(19) United States
(12) Patent Application Publication
(10) Pub. No.: US 2010/0008332 A1
(43) Pub. Date: Jan. 14, 2010

(54) Method for half-and full-duplex subscriber station operation in frequency division duplex systems

(76) Inventors: Krishna Balachandran, Morganville, NJ (US); Doru Calin, Manalapan, NJ (US); Shyam P. Parekh, Orinda, CA (US); Ashok N. Rudrapatna, Basking Ridge, NJ (US)

Correspondence Address: Lucent Technologies Inc.;Docket Administrator-Room 2F-192, 600-700 Mountain Ave., Murray Hill, NJ, 07974-0636, US

(21) Appl. No.: 12/217,867

(22) Filed: Jul. 9, 2008

(51) Int. Cl. H04J 3/00

(52) U.S. Cl. 370/336

(57) ABSTRACT

The present invention provides a novel framing structure that can be used to smoothly evolve a Time Division Duplex (TDD) wireless communications technology to a Frequency Division Duplex wireless communications technology. A method for establishing the start time of an uplink frame that is offset in relation to a downlink frame by an allocation start time is provided. In addition, methods of allocating downlink and uplink resources for half-duplex and full frequency division duplex operation with adequate provisions for transmit-receive and receive-transmit time gaps are also provided.

### FIELD OF THE INVENTION

This invention relates generally to communication systems, and more particularly to Frequency Division Duplex (FDD) Orthogonal Frequency Division Multiple Access (OFDMA) systems.

### BACKGROUND OF THE INVENTION

Orthogonal Frequency Division Multiple Access (OFDMA) technologies based on the IEEE 802.16e/m and Universal Mobile Telecommunications System-Long Term Evolution (UMTS-LTE) are well-positioned to become the technologies of choice beyond 3G cellular. IEEE 802.16e supports a number of advanced capabilities, such as scalable bandwidth, distributed and adjacent subcarrier based methods of subchannelization, and multiple antenna techniques. IEEE 802.16e also mirrors several resource control capabilities found in 3G systems.

One limitation of IEEE 802.16e is that it is currently limited in practice to TDD operation where a single frequency carrier is used for both the downlink and uplink, and the downlink and uplink are separated in time. Industry implementations of this standard are currently limited to a Time Division Duplex (TDD) profile specified by the WiMAX Forum.

FIG. 1 illustrates the current IEEE 802.16e TDD frame structure 100. Each frame is partitioned into downlink sub-frames 101 and uplink sub-frames 102. Downlink sub-frames 101 begin by transmitting control overhead including a preamble 111, a Frame Control Header (FCH) message 121, a downlink map (DL-MAP) message 131, and an uplink map (UL-MAP) message 141.

Preamble 111 may be used for frame synchronization, channel state estimation, received signal strength and Signal-To-Interference-Plus-Noise Ratio (SINR) estimation.

Frame Control Header (FCH) message 121, downlink map (DL-MAP) message 131, and uplink map (UL-MAP) message 141 describe the structure and composition of the frame.

Time gaps, denoted as TTG (Transmit-to-Receive Transition Gap) 103 and RTG (Receive-to-Transmit Transition Gap) 104, are preferably inserted between downlink sub-frame 101 and uplink sub-frame 102, and at the end of each frame, respectively, in order to allow transitions between transmission and reception functions.

Frequency Division Duplex (FDD) operation is of great interest to operators that own paired spectrum. However, interoperable support of FDD requires a new framing structure definition which clearly specifies the downlink and uplink timing relationships as it relates to base station (BS) and mobile station (MS) operation. The terms mobile station and subscriber station are used interchangeably herein.

When defining a framing structure, a number of considerations should be taken into account. A first consideration is minimizing modifications of existing TDD frame structures so that excessive hardware changes to current TDD implementations will not be needed.

A second consideration is the support of Half-Duplex FDD (H-FDD) subscriber station operation. The elimination of duplexers in subscriber stations makes it much easier to have low cost terminals and to evolve TDD terminal ASICs to full FDD capability.

A third consideration is the co-existence of mobile stations that support H-FDD and full FDD operation in the same sector carrier. This will ensure that operator investments in H-FDD terminals are preserved as terminals become more complex and evolve to full FDD capability.

A fourth consideration is that overhead be reduced relative to TDD. At a minimum, it should be no worse than the TDD case. There is also an improved link budget relative to TDD.

A fifth consideration is to maximize the utilization of the air interface resources by minimizing idle times.

These capabilities are necessary in order to ensure that systems can quickly migrate from TDD to FDD operation, allow simpler H-FDD subscriber stations to be deployed and offer improvements that will make WiMAX-based OFDMA systems competitive with other systems based on other FDD technologies.

Framing structure solutions that have been previously proposed for this problem assume a synchronized downlink and uplink frame structure and have a number of disadvantages such as increased MAP overhead and the grouping of subscriber stations into zones which can result in a somewhat degraded link budget for the uplink.

### BRIEF SUMMARY OF THE INVENTION

An exemplary embodiment of the present invention allows the start of an uplink frame to be offset relative to the downlink frame. In an exemplary embodiment, the offset is denoted by the Allocation Start Time (AST). The AST is preferably signaled by the Base Station (BS) to the Subscriber station (SS) so the SS knows both the downlink (DL) and uplink (UL) frame start and end times.

The present invention also allows for enforcement of transition gaps from receive-to-transmit and transmit-to-receive on a per-subscriber basis as opposed to a system-wide basis. In addition, the present invention utilizes resource allocation rules that are enforced upon receipt of resource allocation messages, such as MAP messages, to establish precedence on whether a mobile station is required to transmit or receive during a particular period.

The base station can support different frame durations (FDs) of interest, including but not limited to 2.5 ms, 5 ms and 10 ms frames. Longer frame durations have a number of benefits in terms of reduced overhead and improved link budget but shorter frames offer the possibility of improved latency. It is possible for a H-FDD subscriber station's uplink transmission to be scheduled such that it can receive the control region in a particular downlink frame, receive downlink data in the same frame and subsequently transmit on the uplink according to the constraining transition gaps. Note, however, that if a subscriber station happens to miss a downlink control region which includes a preamble and/or a resource allocation message (MAP in the case of WiMAX) when transmitting on the uplink, it cannot receive data during that downlink frame nor get allocation for the corresponding UL frame.

Full-duplex operation is allowed for subscriber stations that possess this capability. These subscriber stations can co-exist with other H-FDD capable subscriber stations and share the radio resources as determined by the scheduler. Since simultaneous transmission and reception is possible for full-duplex mobiles, there is no need for transition gaps.

Regardless of the assumed frame duration, transmissions on the UL can preferably span the entire frame period. This provides a link budget advantage since data bursts may be transmitted on fewer sub-channels and more symbols thus improving SINR on UL. It also allows larger bursts to be scheduled on a pre-determined number of sub-channels thus reducing the fraction of MAC header and any cyclic redundancy check (CRC) overhead. Partitioning the frame into zones for the purpose of half-duplex FDD operation may lead to loss in coverage for cell-edge users.

The BS scheduler can maximize the utilization of both DL and UL frames for HFDD SSs that cannot support simultaneous DL-UL operation by taking into account several factors that include (but not limited to): known locations of UL multiple access channel (Ranging channel in 802.16), CQI and ACK/NACK feedback in support of DL operation, and adequate provision for SSRTG/SSTTG gaps to switch between DL and UL allocation during nominal DL and UL frames. In an exemplary embodiment, any gap that arises between successive DL or UL frames due to the transmission of an integer valued number of symbols within a single frame, may be minimized by proper choice of OFDMA symbol Cyclic Prefix duration in relation to the OFDMA symbol duration.

Half duplex capable SS are able to receive DL data and control and transmit UL data and control without conflict. In addition, the SS can process control messages on DL and get ready to transmit on the UL. The HFDD SS can receive control and data on a part of the DL frame while also transmitting UL control and data on a part of the concurrent UL frame.

For half-duplex FDD operation in WiMAX, maximal commonality is maintained with the existing WiMAX TDD profile. In an exemplary embodiment, the AST and duration of uplink allocation are signaled via existing fields in the UL-MAP. In an alternate exemplary embodiment, the AST and duration of allocation are signaled via UCD/DCD messages. These features along with the preservation of the uplink/downlink frame timing relationship ensure that compatibility with ASIC designs is maintained thus reducing the time to market for a WiMAX FDD solution.

### BRIEF DESCRIPTION OF THE SEVERAL VIEWS OF THE DRAWINGS

FIG. 1 depicts an OFDMA frame with TDD operation in accordance with the prior art.

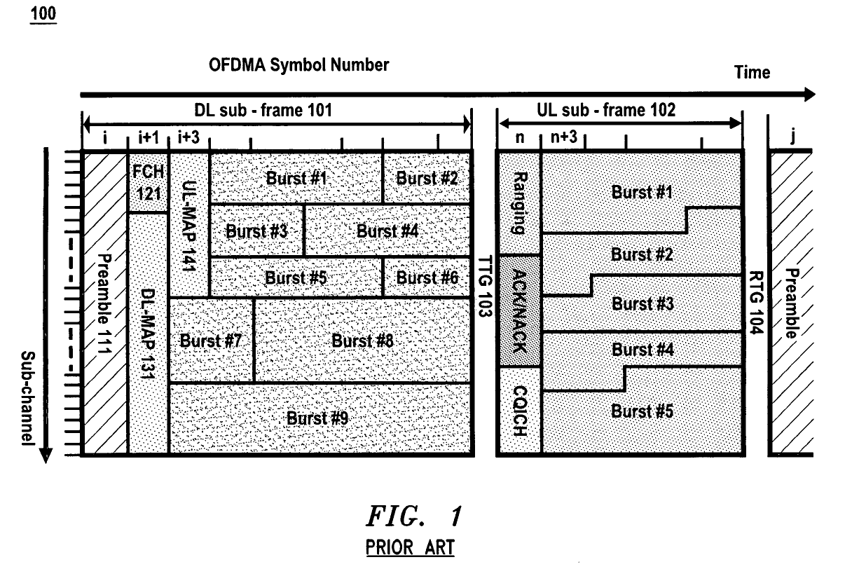

FIG. 2 depicts an FDD frame structure from the base station perspective in accordance with an exemplary embodiment of the present invention.

FIG. 3 depicts an FDD frame structure illustrating H-FDD subscriber station operation in accordance with an exemplary embodiment of the present invention.

FIG. 4 depicts an FDD frame structure illustrating operation of H-FDD and full FDD subscriber stations including the receive-transmit and transmit to receive gaps that are enforced on a per-subscriber basis in accordance with an exemplary embodiment of the present invention.

FIG. 5 depicts an FDD frame structure illustrating resource allocation to an H-FDD subscriber station running a downlink intensive application in accordance with an exemplary embodiment of the present invention.

FIG. 6 depicts an FDD frame structure illustrating resource allocation to an H-FDD subscriber station running an uplink intensive application in accordance with an exemplary embodiment of the present invention.

### DETAILED DESCRIPTION OF THE INVENTION

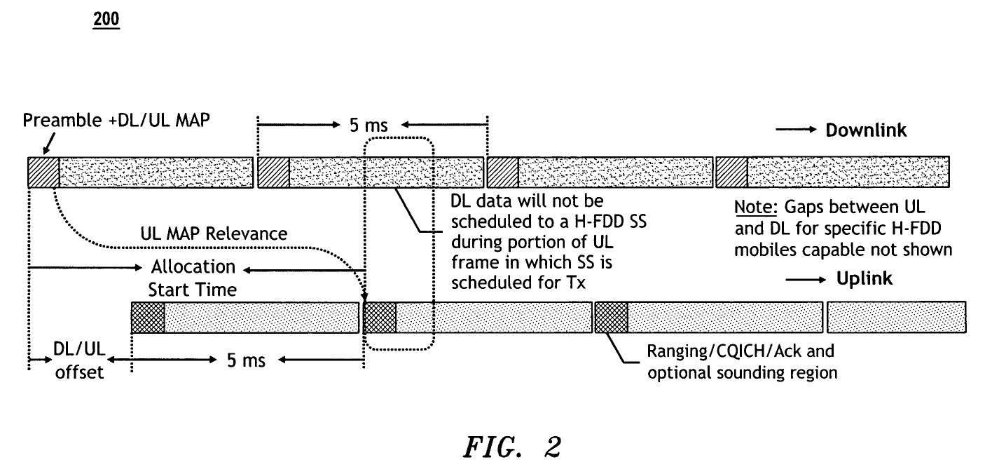

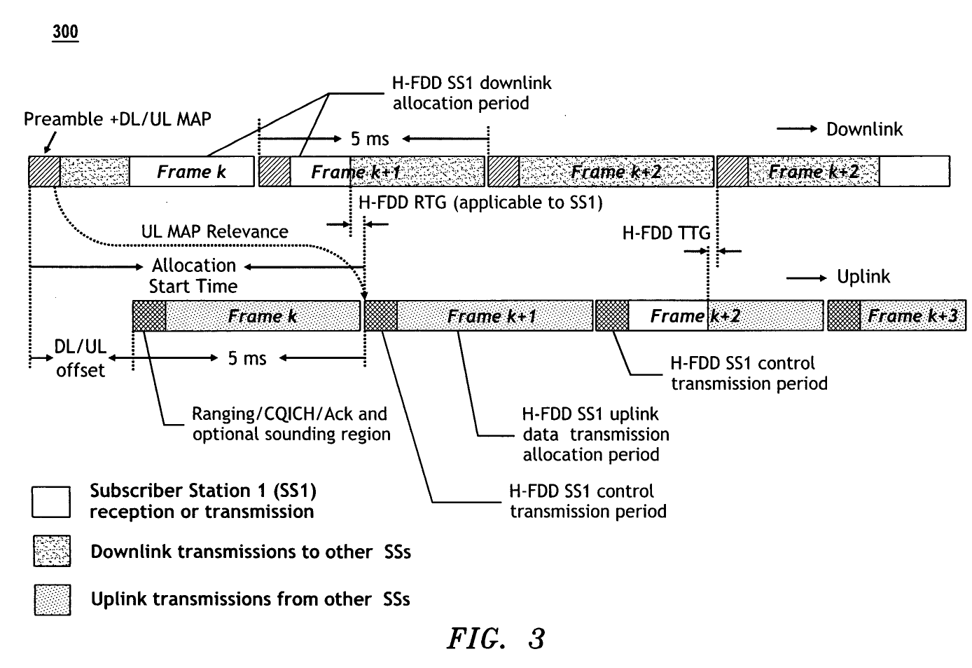

FIGS. 2 through 6 depict exemplary embodiments of the present invention, and more particularly embodiments that are applicable to an IEEE 802.16e/WiMAX based system. FIG. 2 illustrates the frame structure 200 from a base station perspective while FIG. 3 illustrates H-FDD operation with proposed frame structure 300; the DL/UL offset is shown modulo FD.

An exemplary embodiment of the present invention allows the start of the uplink frame to be offset relative to the downlink by an AST (Allocation Start Time). The AST is preferably signaled by the Base Station (BS) to the Subscriber Station (SS) so it knows both the DL and UL frame start and end times. In an exemplary system embodiment as shown in FIGS. 2 and 3, the AST can assume any value greater than the FD but less than 2*FD, where FD denotes the greater of the duration of one Downlink (DL) or Uplink (UL) frame. In this case because of the periodic nature of the frames, the actual observed DL-UL frame offset would be AST modulo FD. This maintains a similar behavior to TDD systems as far as relevance of the downlink and uplink resource allocation via resource allocation control messages (called MAP messages in IEEE 802.16e/WiMAX) is concerned. In an alternate exemplary embodiment, the AST may not be restricted to the above interval, e.g. it can be less than FD or greater than 2*FD. In particular, reduced allocation start time of less than a frame will become possible as processing power increases in subscriber stations over time and will allow the DL to UL resource allocation latency for a given terminal to be reduced further.

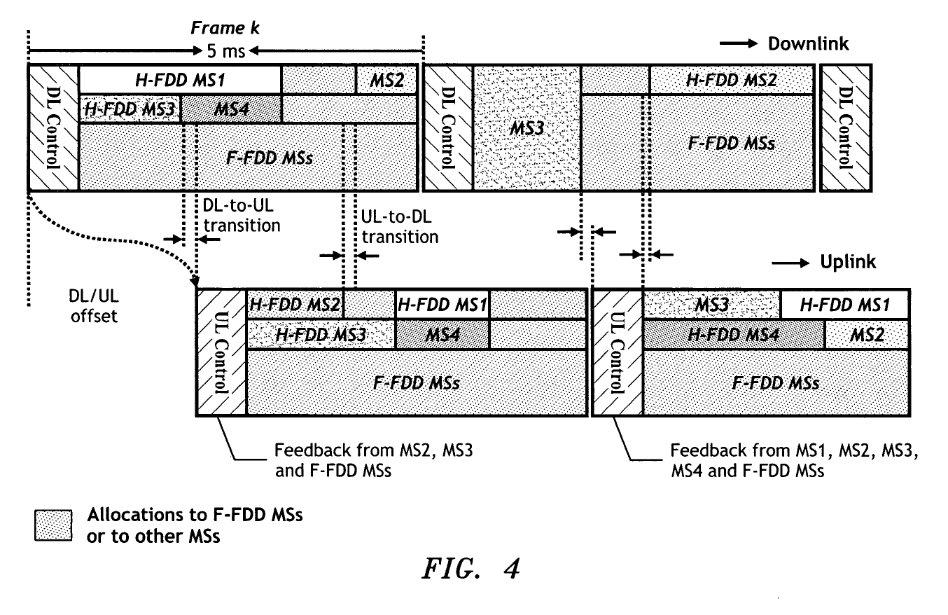

Exemplary embodiments of the present invention shown in FIGS. 3 and 4 also illustrate transition gaps from receive-to-transmit and transmit-to receive that are preferably enforced on a per-subscriber station basis as opposed to a system wide basis. A transition gap for one subscriber station may be utilized to send data to or receive data from another subscriber station. This ensures that there is no inefficiency introduced into the system on account of transmit/receive transition gaps.

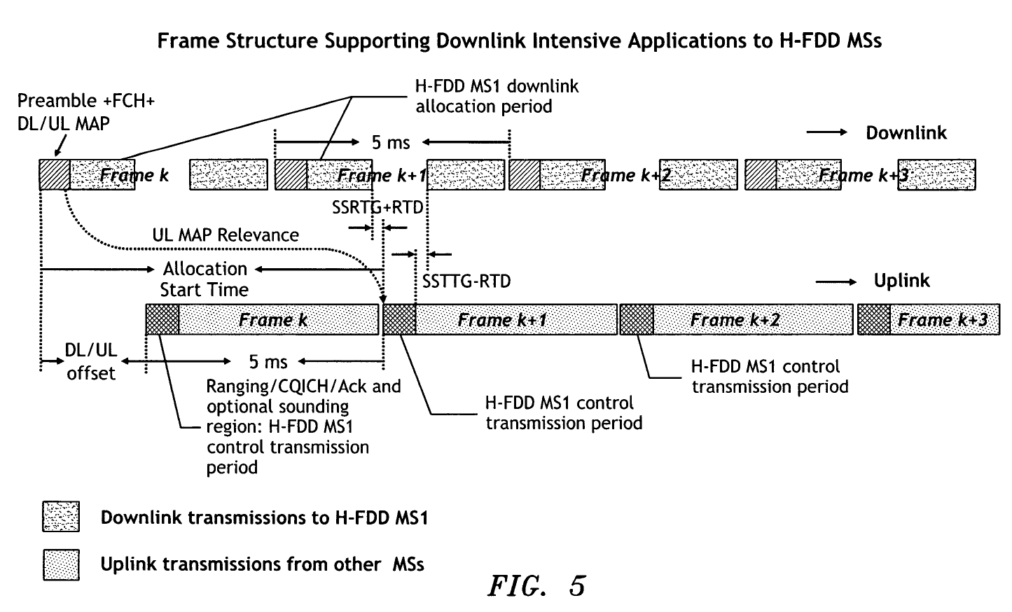

FIG. 5 illustrates an exemplary embodiment of a downlink intensive application to a half-duplex capable subscriber station. In the exemplary embodiment depicted in FIG. 5, the subscriber station can be in receive mode during all times except during the uplink control region. During the uplink control region, feedback for the downlink is preferably transmitted by the subscriber station and during transition gaps between the downlink allocation and the uplink control region.

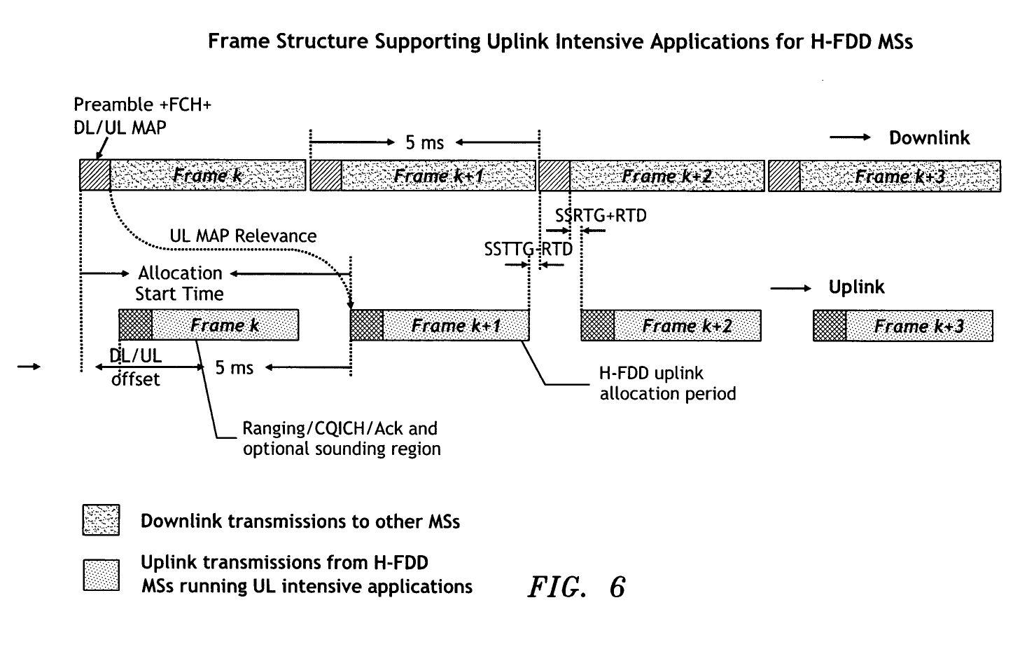

FIG. 6 illustrates an exemplary embodiment of an uplink intensive application to a half-duplex capable subscriber station. In this exemplary embodiment, the subscriber station can be in transmit mode at all times except during the downlink control region where the preamble and MAP messages are transmitted by the base station.

In addition to the enforcement of transition gaps, resource allocation rules are preferably enforced upon receipt of resource allocation messages (e.g., MAP) in order to establish precedence on whether a mobile station is required to transmit or receive during a particular period. For example, base stations typically broadcast system parameters, such as the number of subchannels to be used in a sector, periodically on the DL. These broadcast messages (BMs) are preferably intended for all subscriber stations and special precedence rules need to be defined for half-duplex capable subscriber stations to resolve conflicts between broadcast message reception and uplink transmission. In an exemplary embodiment, a base station avoids scheduling any UL transmissions when scheduling BMs. This enables all half duplex MSs to get the broadcast messages while wasting a part of the UL transmission bandwidth.

In an alternate exemplary embodiment, the base station avoids wasting UL bandwidth by scheduling UL transmissions as it normally would to selected H-FDD SSs. The selected SSs preferably give higher priority to UL grants over any BMs scheduled to overlap with the UL transmissions. One possible way for a SS to recover missed BMs due to conflicts with UL transmissions is for the BS to embed the required BM content within the DL bearer transmission to the SS as user traffic. Otherwise, the SS will have to receive the BM at one of the next broadcast reception opportunities, which could result in some additional delay for BM updates. The BS scheduler can ensure that not too many BM and UL allocation conflicts take place, but the above precedence rules allow operation even with conflicts.

The present invention provides a number of benefits, in particular for OFDMA systems based on IEEE 802.16e/WiMAX and for next generation WiMAX systems that will be based on the IEEE 802.16m standard. Examples of benefits include compatibility with existing TDD frame structures, smooth evolution to full FDD, similar resource allocation overhead to TDD and reduced overhead relative to other FDD solutions (translates into higher capacity), improved link budget, and reduced header/trailer overhead fractions which translate into a coverage improvement.

An additional benefit of the present invention is compatibility with TDD profile and existing hardware solutions thus reducing the time-to-market significantly for a FDD solution. Further, under the assumption of 5 ms frame duration, the present invention provides a 2× reduction in the fixed part of the MAP overhead relative to alternative solutions such as 2.5 ms DL/UL frames, that have been proposed. Under the assumption of scheduling the same number of bursts within a frame duration, the variable portion of the MAP overhead is also reduced by a factor of 2. The present invention also provides improved uplink link budget relative to TDD.

Further, an exemplary embodiment of the present invention provides support of different frame durations of interest (e.g. 2.5 ms, 5 ms and 10 ms frames). As shown in an exemplary embodiment in FIG. 4, it is possible for a half-duplex capable subscriber station's uplink transmission to be scheduled such that it can receive the control region in a particular downlink frame, receive downlink data in the same frame and subsequently transmit on the uplink. This is illustrated in FIG. 4 for mobile station 1 (MS1), mobile station 3 (MS3) and mobile station 4 (MS4). Note, however, that if a subscriber station happens to miss a downlink control region which includes a preamble and/or a resource allocation message (MAP in the case of WiMAX) when transmitting on the uplink, it cannot receive data during that downlink frame.

An exemplary embodiment depicted in FIG. 4 illustrates the case where mobile station 1 (MS1) misses the DL control region in frame k+1 due to an uplink transmission in frame k and cannot be scheduled to receive downlink data during frame k+1 as a consequence. However, full-duplex operation is allowed for subscriber stations that possess this capability. These subscriber stations can co-exist with other H-FDD capable subscriber stations and share the radio resources as determined by the scheduler. Since simultaneous transmission and reception is possible for full-duplex mobiles, there is no need for transition gaps. Also during these times, other subscriber stations who are not scheduled for UL transmission can listen to the DL control messages and subsequently receive DL data transmission.

Regardless of the frame duration, transmissions on the UL preferably span the entire frame period. This provides a link budget advantage since data bursts may be transmitted on fewer sub-channels and more symbols thus improving SINR on UL. For example, consider the case where a burst is scheduled on a single sub-channel requiring all usable symbols (S_{FDD}) in the uplink frame. This case may be compared with a TDD case where the same transmission needs to be scheduled across S_{TDD} symbols where S_{FDD}>S_{TDD}. In this case, more than one sub-channel needs to be used to schedule the transmission in TDD. In the specific case where (S_{FDD}/S_{TDD})=2, the Signal-to-Interference-Plus-Noise Ratio improves by 3 dB in the FDD case (assuming that interference is similar in the 2 cases) relative to TDD. Partitioning the frame into zones for the purpose of FDD operation (as has been suggested in some alternative proposals) may lead to loss in coverage for cell-edge users.

An exemplary embodiment of the present invention also allows larger bursts to be scheduled on a pre-determined number of sub-channels, thus reducing the fraction of MAC header and any cyclic redundancy check (CRC) overhead. In an exemplary TDD system embodiment with 15 usable symbols for uplink data and a transmission at Rate ½ QPSK (Quadrature phase-shift keying) with hybrid Automatic Repeat Request using PUSC, the overhead fraction for a burst spanning a single subchannel is 64/240˜27%. Whereas for FDD (or H-FDD) operation with 48 usable symbols, the overhead fraction reduces to 64/(16*48)˜8.3% overhead.

For FDD operation in WiMAX, maximal commonality is maintained with the existing WiMAX TDD profile. The ALLOCATION START TIME and duration of allocation may be signaled via existing fields in the UL-MAP message. These features along with the preservation of the uplink/downlink frame timing relationship ensure that compatibility with ASIC designs is maintained thus reducing the time to market for a WiMAX FDD solution.

While this invention has been described in terms of certain examples thereof, it is not intended that it be limited to the above description, but rather only to the extent set forth in the claims that follow.

We claim:

1. A method of allocating downlink and uplink resources, the method comprising:
determining a downlink start time for a downlink frame; and
determining an uplink start time for an uplink frame, the uplink start time being offset from the downlink start time by an allocation start time.

2. A method of allocating downlink and uplink resources in accordance with claim 1, further comprising the step of determining a time gap, wherein the time gap comprises the time a mobile station requires to switch between a downlink frame and an uplink frame, the method further comprising the step of allocating resources for the mobile unit such that the allocation start time is greater than the time gap.

3. A method of allocating downlink and uplink resources in accordance with claim 2, wherein the step of determining a time gap comprises determining a time gap according to the needs of an application.

4. A method of allocating downlink and uplink resources in accordance with claim 2, wherein the step of determining a time gap comprises determining a time gap for an uplink intensive application that includes a downlink control region.

5. A method of allocating downlink and uplink resources in accordance with claim 2, wherein the step of determining a time gap comprises determining a time gap for an uplink intensive application that includes a receive-to-transmit transition gap.

6. A method of allocating downlink and uplink resources in accordance with claim 2, wherein the step of determining a time gap comprises determining a time gap for an uplink intensive application that includes a transmit-to-receive transition gap.

7. A method of allocating downlink and uplink resources in accordance with claim 2, wherein the step of determining a time gap comprises determining a time gap for a downlink intensive application that includes an uplink control region.

8. A method of allocating downlink and uplink resources in accordance with claim 2, wherein the step of determining a time gap comprises determining a time gap for a downlink intensive application that includes a receive-to-transmit transition gap.

9. A method of allocating downlink and uplink resources in accordance with claim 2, wherein the step of determining a time gap comprises determining a time gap for a downlink intensive application that includes a transmit-to-receive transition gap.

10. A method of allocating downlink and uplink resources in accordance with claim 2, wherein the step of determining a time gap comprises determining a time gap on a per-mobile station basis.

11. A method of allocating downlink and uplink resources in accordance with claim 1, the method further comprising the step of transmitting the allocation start time to a mobile station.

12. A method of allocating downlink and uplink resources in accordance with claim 1, wherein the downlink frame has a downlink duration and the uplink frame has an uplink duration, and wherein the allocation start time is greater than the maximum of the downlink duration and the uplink duration.

13. A method of allocating downlink and uplink resources in accordance with claim 12, wherein the allocation start time is shorter than twice the maximum of the downlink duration and the uplink duration.

14. A method of allocating downlink and uplink resources in accordance with claim 1, wherein the allocation start time is signaled via a UCD/DCD message.

15. A method of allocating downlink and uplink resources in accordance with claim 1, the method further comprising the step of scheduling a series of uplink resource allocations for a plurality of mobile stations in communication with a base station, wherein the series of uplink resource allocations are such that the base station can transmit a broadcast message to all of the plurality of mobile stations.

16. A method of allocating downlink and uplink resources in accordance with claim 1, the method further comprising the step of transmitting an uplink message that spans the entire uplink frame period.

17. A method of allocating downlink and uplink resources in accordance with claim 1, wherein the step of determining an uplink start time comprises determining an uplink start time utilizing known locations of uplink control regions.

18. A method of allocating downlink and uplink resources in accordance with claim 1, further comprising the step of signaling the allocation start time via existing fields in a UL-MAP.

19. A method of allocating downlink and uplink resources in accordance with claim 1, the method further comprising the step of scheduling a series of uplink resource allocations for a plurality of mobile stations in communication with a base station, wherein uplink transmissions corresponding to the series of uplink resource allocations take precedence over reception of broadcast messages transmitted by the base station during the series of uplink resource allocations.

20. A method of allocating downlink and uplink resources in accordance with claim 19, the method further comprising the step of transmitting as user data any broadcast messages missed by a plurality of mobile stations due to the precedence of uplink transmissions.
